(19) United States
(12) Patent Application Publication
(10) Pub. No.: US 2010/0110024 A1
(43) Pub. Date: May 6, 2010

(54) METHOD FOR PROVIDING USER INTERFACE USING DMD AND DLP DISPLAY APPARATUS USING THE METHOD

(75) Inventors: Ki-yong KIM, Seoul (KR); Seong-il CHO, Seoul (KR); Jung-min KANG, Seoul (KR); Young-kwang SEO, Seoul (KR); Ki-jun JEONG, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/489,523

(22) Filed: Jun. 23, 2009

(30) Foreign Application Priority Data
Oct. 30, 2008 (KR) 10-2008-0107108

(51) Int. Cl. G06F 3/041; G02B 26/00

(52) U.S. Cl. 345/173; 359/292

(57) ABSTRACT

A method for providing a user interface, and a Digital Light Processing (DLP) display apparatus using the method. In the DLP display apparatus, a Digital Micro-mirror Device (DMD) reflects light projected on a screen by a light source, and an image sensor detects the light reflected from the DMD, so as to easily provide a user interface for the DLP display apparatus.

### CROSS-REFERENCE TO RELATED APPLICATIONS

This application claims priority from Korean Patent Application No. 10-2008-0107108, filed on Oct. 30, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a method for providing a user interface, and a Digital Light Processing (DLP) display apparatus using the method, and more particularly, to a method for providing a user interface for a DLP display apparatus to receive a user command using touch by a user, and the DLP display apparatus using the method.

2. Description of the Related Art

Digital Light Processing (DLP) televisions, called the third generation of projection televisions, use a semiconductor chip, consisting of more than 1.3 millions of mirrors that can be separately controlled, known as a Digital Micro-mirror Device (DMD).

In DLP televisions, an image is created on a screen by passing a light beam emitted from a lamp through a color wheel coated with an RGB filter, which generates the RGB primary colors, reflecting the RGB primary colors from each pixel of a DMD.

In DLP televisions, it is easy to enlarge a screen, and the cost for enlarging a screen is low. Accordingly, DLP televisions are generally used for presentations. In order to better use DLP televisions in presentation, a touchscreen function is needed.

However, in order to add the touchscreen function to DLP televisions, a device for recognizing a user's touch is additionally required, thereby increasing the television's price. In addition, if a separate device for recognizing the user's touch is installed, an optic axis of light displayed on the screen and an optic axis of light used to recognize touch do not coincide, so calibration between the DLP television and the device for recognizing the user's touch is required.

As described above, the device for recognizing touch on the DLP television requires additional components and additional costs. Therefore, there is a demand for more easily providing a user interface.

### SUMMARY OF THE INVENTION

Exemplary embodiments of the present invention address at least the above problems and/or disadvantages, and other disadvantages not described above. Also, the present invention is not required to overcome the disadvantages described above, and an exemplary embodiment of the present invention may not overcome any of the problems described above.

An aspect of the present invention provides a method for providing a user interface, by which a Digital Micro-mirror Device (DMD) reflects light emitted from a light source to a screen and an image sensor detects the light reflected from the DMD, and a digital light processing (DLP) display apparatus using the method, so as to more conveniently provide a user interface for the DLP display apparatus.

According to an exemplary aspect of the present invention, there is provided a Digital Light Processing (DLP) display apparatus including a light source which projects light on a screen, a Digital Micro-mirror Device (DMD) which includes a plurality of micro-mirrors, and if the light projected from the light source is diffused on the screen, the DMD reflects the diffused light, and an image sensor which detects the light reflected from the DMD.

The image sensor may detect light reflected from at least one micro-mirror which is turned off in the DMD.

The DMD may turn off all of the micro-mirrors in the DMD for a certain period among periods corresponding to a single frame.

The light source may project the light for total reflection in the screen, and the total-reflected light may be diffused on an area touched by a user on the screen.

The DLP display apparatus may further include a control unit which determines the touched area on the screen using information detected by the image sensor.

The light source may use an infrared ray.

The light source may externally project the light onto a surface of the screen, and the projected light may be diffused on the surface of the screen.

The DLP display apparatus may further include a control unit which determines an area onto which the light is projected on the screen using information detected by the image sensor.

The light source may use a visible ray.

According to another exemplary aspect of the present invention, there is provided a method for providing a user interface for a Digital Light Processing (DLP) display apparatus, the method including projecting light on a screen, at a Digital Micro-mirror Device (DMD), if the projected light is diffused on the screen, reflecting the diffused light, and at an image sensor, detecting the light reflected from the DMD.

In the detecting operation, light reflected from at least one micro-mirror which is turned off in the DMD may be detected.

The method may further include at the DMD, turning off all of the micro-mirrors in the DMD for a certain period among periods corresponding to a single frame.

In the projecting operation, the light may be projected for total reflection in the screen, and the total-reflected light may be diffused on an area touched by a user on the screen.

The method may further include determining the touched area on the screen using information detected by the image sensor.

The light projected for total reflection in the screen may be an infrared ray.

In the projecting operation, the light may be externally projected onto a surface of the screen, and the projected light may be diffused on the surface of the screen.

The method may further include determining an area onto which the light is projected on the screen using information detected by the image sensor.

The externally projected light may be a visible ray.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a detailed configuration of a Digital Light Processing (DLP) display apparatus according to an exemplary embodiment of the present invention;

FIG. 2 is a flow chart illustrating a method for providing a user interface for a DLP display apparatus capable of recognizing a user's touch according to an exemplary embodiment of the present invention;

FIG. 3 is a flow chart illustrating a method for providing a user interface for a DLP display apparatus capable of recognizing light projected to a screen according to another exemplary embodiment of the present invention;

FIG. 4 illustrates a process of reflecting light of a display lamp from a DMD to a screen and displaying an image on the screen in a DLP display apparatus according to an exemplary embodiment of the present invention;

FIG. 5 illustrates a user touching a second area on the screen according to an exemplary embodiment of the present invention;

FIG. 6 illustrates a user touching a first area on the screen according to an exemplary embodiment of the present invention;

FIG. 7 illustrates light projected from a light source to a second area on the screen according to an exemplary embodiment of the present invention; and

FIG. 8 illustrates light projected from a light source to a first area on the screen according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

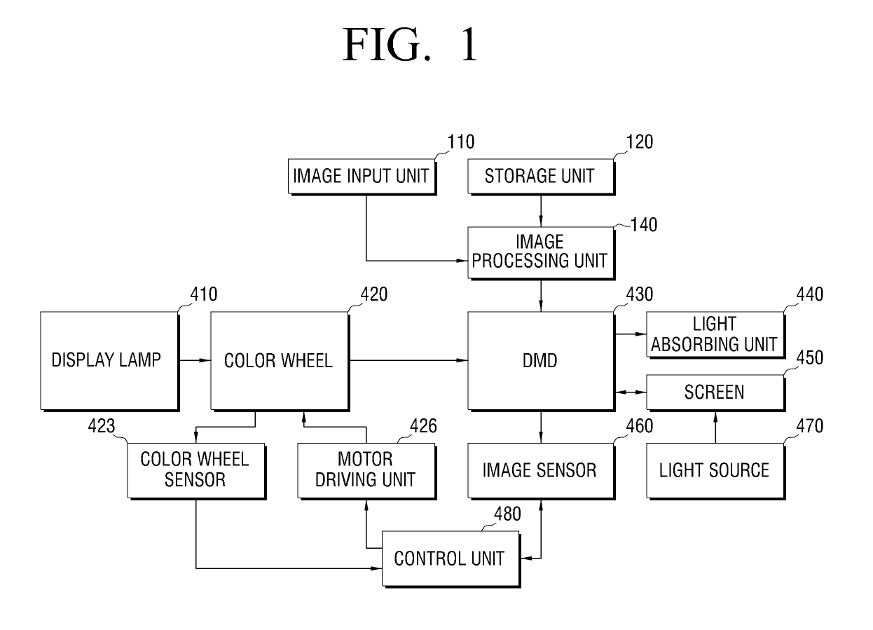

FIG. 1 is a block diagram illustrating a detailed configuration of a Digital Light Processing (DLP) display apparatus according to an exemplary embodiment of the present invention. As illustrated in FIG. 1, the DLP display apparatus may include an image input unit 110, a storage unit 120, an image processing unit 140, a display lamp 410, a color wheel 420, a color wheel sensor 423, a motor driving unit 426, a Digital Micro-mirror Device (DMD) 430, a light absorbing unit 440, a screen 450, an image sensor 460, a light source 470, and a control unit 480.

The image input unit 110 receives image information from an external device (not shown). The image input unit 110 may include input terminals corresponding to the standards of D-sub, Digital Visual Interface (DVI), and High-Definition Multimedia Interface (HDMI).

The storage unit 120 stores image data, and transmits the image data to the image processing unit 140.

The image processing unit 140 performs signal-processing, such as video decoding and video scaling, for an image signal which is input from the image input unit 110 or received from the storage unit 120. Subsequently, the image processing unit 140 converts the image signal into image data of a format for driving the DMD 430, and transmits the image data to the DMD 430.

The display lamp 410 emits a light beam using supplied power, and irradiates the light beam to the DMD 430 through the color wheel 420.

The color wheel 420 filters the light beam emitted from the display lamp 410 and thus outputs the RGB primary colors: red, green, and blue. The color wheel 420 rotates at a certain speed and sequentially irradiates red, green, and blue light to the DMD 430 at certain time intervals.

The color wheel sensor 423 examines the rotational state of the color wheel 420 which is currently operating. That is, if the color wheel sensor 423 provides the control unit 480 with information regarding the rotational state of the color wheel 420, the control unit 480 senses and controls the phase and rotational speed of the color wheel 420 using the information.

The motor driving unit 426 drives a motor which is connected to the color wheel 420.

The DMD 430 may include approximately 1.3 million micro-mirrors. The DMD 430 determines whether to turn each micro-mirror on or off according to the image data received from the image processing unit 140. The DMD 430 selectively reflects light irradiated from the display lamp 410 using each micro-mirror so that an image can be created on the screen 450. That is, the DMD 430 controls the RGB color light reflected from the micro-mirrors of the DMD 430 based on the image data received from the image processing unit 140, thereby creating an image to be displayed on the screen 450.

In addition, if light emitted from the light source 470 is diffused on the screen 450, the DMD 430 reflects the diffused light to the image sensor 460. The light source 470 is a light source which is separately added to provide a user interface, and a detailed description of the light source 470 will be given later.

The DMD 430 may turn off the micro-mirrors for a certain time from among the periods corresponding to a single frame. This is because if the micro-mirrors in the DMD 430 are turned on, the image sensor 460 cannot detect light. Accordingly, if the micro-mirrors in the DMD 430 are turned off for a certain period, the image sensor 460 can detect light of the light source 470 diffused on the screen 450 for the certain period. For example, if there are a total of 256 levels to express the brightness of a frame, the DMD 430 reduces the levels to express the brightness to be 240, and turns off the micro-mirrors in the DMD 430 for a period corresponding to the 16 remaining levels.

As described above, if the DMD 430 turns off the micro-mirrors for a certain period from among the periods corresponding to a single frame, touch by the user on the screen 450 can also be recognized during the period.

The light absorbing unit 440 absorbs light, which is reflected from a micro-mirror in the DMD 430, when the micro-mirror is turned off Accordingly, if a micro-mirror in the DMD 430 is turned off, light is not projected to an area of the screen 450 corresponding to the micro-mirror.

The screen 450 receives light reflected from the DMD 430, from among light emitted from the display lamp 410, and displays an image. More specifically, only light reflected from a micro-mirror which is turned on from among the micro-mirrors in the DMD 430 is projected on the screen 450 so as to express an image.

The image sensor 460 detects light reflected from DMD 430. More specifically, if light emitted from the light source 470 is diffused on the screen 450 and is reflected from the DMD 430, the image sensor 460 detects the light reflected from the DMD 430. In particular, the image sensor 460 detects light reflected from at least one micro-mirror which is turned off in the DMD 430. Accordingly, the image sensor 460 is disposed on an optical path of light reflected from the micro-mirror in the DMD 430 which is turned off.

The image sensor 460 detects image information regarding the entire screen 450. If light is diffused on the screen 450, a pixel corresponding to a diffused area of the screen 450 from among the pixels of the image sensor 460 detects the diffused light.

Therefore, information detected by the image sensor 460 may be image information in which only the diffused area is expressed brightly on the entire screen 450. That is, information detected by the image sensor 460 is image information indicating whether or not light is diffused for the entire screen 450. Since the diffused area of the screen 450 may be an area touched by the user, or an area on which the light source 470 projects light, the control unit 480 can determine the touched area or the projected area using the information detected by the image sensor 460.

The image sensor 460 may be implemented as a charge-coupled device (CCD) image sensor or a complementary metal-oxide semiconductor (CMOS) image sensor.

As described above, since the image sensor 460 detects light diffused on the screen 450, a touched area of the screen 450 or an area of the screen 450 on which the light source 470 projects light can be detected.

The light source 470 projects light on the screen 450. More specifically, the light source 470 may project light for total reflection in the screen 450, or may externally project light onto the surface of the screen 450.

If the light source 470 projects light for total reflection in the screen 450, the light is diffused on a touched area of the screen 450, and the diffused light is reflected by the DMD 430 and detected by the image sensor 460. The control unit 480 determines the touched area of the screen 450 using information detected by the image sensor 460.

In this case, the light source 470 may use an infrared ray. This is because, although an infrared ray is diffused on the screen 450, the infrared ray cannot be viewed by the user. In addition, because of using the infrared ray, touch by a pen or a touch pen as well as by the user's hand can be recognized.

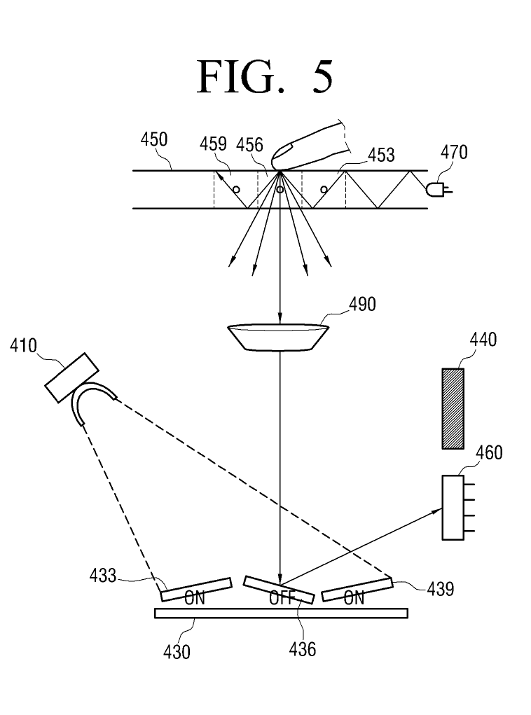

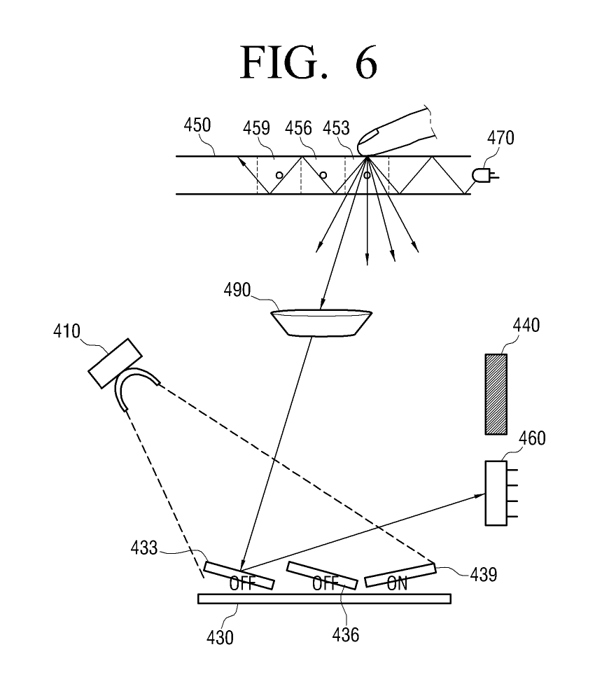

A detailed description of when the light source 470 projects light for total reflection in the screen 450 will be given later with reference to FIGS. 5 and 6.

As described above, the DLP display apparatus can perform a touchscreen function simply by having the image sensor 460 and the light source 470. In this case, since an optic axis of light of the light source 470 is the same as an optic axis of light of the display lamp 410, distortion between a displayed image and a touched area can be minimized, and calibration between coordinates of the image and coordinates of the touch area can be minimized. In addition, since only the image sensor 460 and the light source 470 are added to the DLP display apparatus, the touchscreen function can be implemented with a low cost.

Alternatively, if the light source 470 externally projects light onto the surface of the screen 450, the light is diffused on the surface of the screen 450. The diffused light is reflected by the DMD 430, and detected by the image sensor 460. Subsequently, the control unit determines the projected area on the screen 450 on which the light source 470 projects the light using information detected by the image sensor 460.

In this case, the light source 470 may use a visible ray. For example, the light source 470 may be a laser pointer. More specifically, in a presentation, if a laser pointer projects a ray onto the screen 450 of the DLP display apparatus, the DLP display apparatus detects the projected area on the screen 450. Hereinafter, a “light source recognition function” refers to a function for the DLP display apparatus recognizing an area on which the light source 470 is projected on the screen 450.

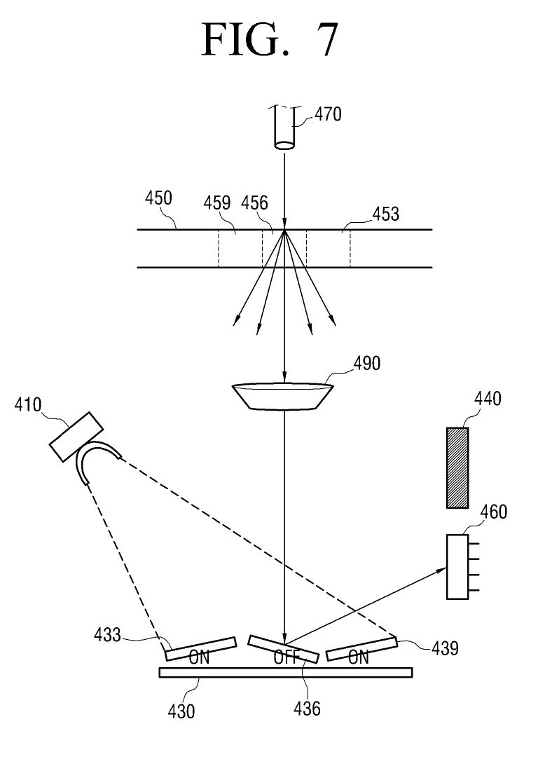

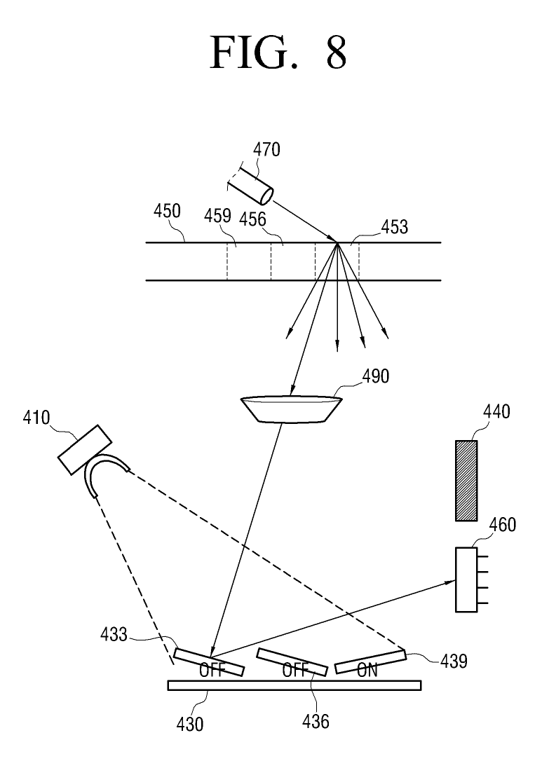

A detailed description of when the light source 470 externally projects light onto the surface of the screen 450 will be given later with reference to FIGS. 7 and 8.

As described above, the DLP display apparatus can perform the light source (for example, a laser pointer) recognition function simply by having the image sensor 460 and the light source 470. In this case, since an optic axis of light of the light source 470 is the same as an optic axis of light of the display lamp 410, distortion between a displayed image and an area on which light of the light source 470 is projected on the screen 450 can be minimized, and calibration between coordinates of the image and coordinates of the projected area on the screen 450 can be minimized. In addition, since only the image sensor 460 and the light source 470 are added to the DLP display apparatus, the light source recognition function can be implemented with a low cost.

The control unit 480 controls the DLP display apparatus. If a user command is input using a manipulation button or a remote control, the control unit 480 outputs a control signal so as to perform the operation in response to the user's command.

In particular, the control unit 480 determines a touched area of the screen 450 or an area on which light of the light source 470 is projected on the screen 450, using information detected by the image sensor 460.

As described above, the DLP display apparatus can provide a user interface such as the touch screen function and the light source recognition function. In particular, since only the image sensor 460 and the light source 470 are added to the DLP display apparatus, the light source recognition function can be implemented with a low cost.

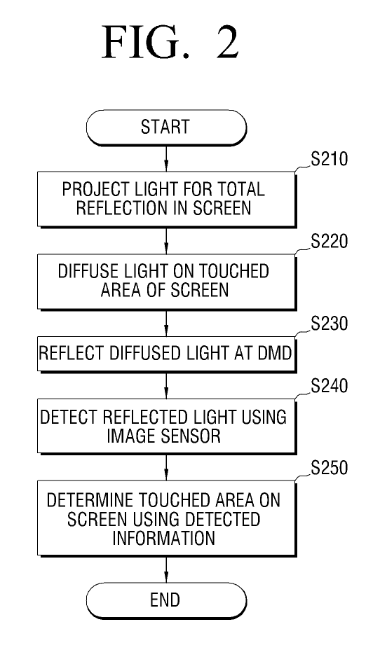

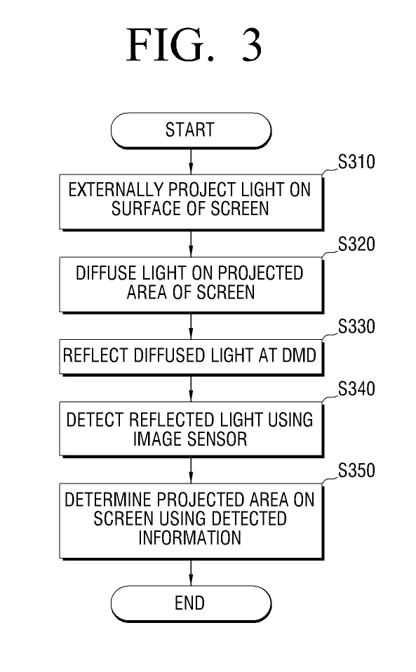

Referring to FIGS. 2 and 3, a method for providing a user interface according to an exemplary embodiment is described in detail.

FIG. 2 is a flow chart illustrating a method for providing a user interface for a DLP display apparatus capable of recognizing a user's touch according to an exemplary embodiment of the present invention.

In operation S210, the light source 470 projects light for total reflection in the screen 450. In this case, the light source 470 uses an infrared ray. This is because, although an infrared ray is diffused on the screen 450, the infrared ray cannot be viewed by the user. In addition, because of using the infrared ray, touch by a pen or a touch pen as well as by the user's hand can be recognized.

In operation S220, if the user touches the screen 450, light totally reflected in the screen 450 is diffused on the touched area of the screen 450.

In operation S230, the DMD 430 reflects the diffused light towards the image sensor 460. In this case, operation S230 further includes an operation that the DMD 430 turns off the micro-mirrors in the DMD 430 for a certain period from among the periods corresponding to a single frame. This is because, if the micro-mirrors in the DMD 430 are turned on, the image sensor 460 cannot detect light. Accordingly, the micro-mirrors in the DMD 430 are turned off.

In operation S240, the image sensor 460 detects the light reflected by the DMD 430. In particular, the image sensor 460 detects light reflected from at least one micro-mirror which is turned off in the DMD 430. Accordingly, the image sensor 460 is disposed on an optical path of light reflected from the micro-mirror that is turned off in the DMD 430.

In operation S250, the control unit 480 determines the touched area of the screen 450 using the information detected by the image sensor 460. The information detected by the image sensor 460 may be image information in which only the diffused area is expressed brightly on the entire screen 450. That is, the information detected by the image sensor 460 is image information indicating whether or not light is diffused for the entire screen 450. Since the diffused area on the screen 450 indicates an area touched by the user, the control unit 480 can determine the touched area on the screen 450 using the information detected by the image sensor 460.

Following this process, the DLP display apparatus can provide the touch screen function.

FIG. 3 is a flow chart illustrating a method for providing a user interface for the DLP display apparatus capable of recognizing light projected to the screen 450 according to another exemplary embodiment of the present invention.

In operation S310, the light source 470 externally projects light onto the surface of the screen 450. In this case, the light source 470 may use a visible ray. For example, the light source 470 may be a laser pointer. More specifically, in a presentation, if a laser pointer projects a ray onto the screen 450 of the DLP display apparatus, the DLP display apparatus detects the projected area on the screen 450. Hereinafter, a “light source recognition function” refers to a function for the DLP display apparatus recognizing an area on which the light source 470 is projected on the screen 450.

In operation S320, the light projected from the outside of the screen 450 is diffused on the surface of the screen 450.

In operation S330, the DMD 430 reflects the diffused light to the image sensor 460. In this case, operation S330 further includes an operation that the DMD 430 turns off the micro-mirrors in the DMD 430 for a certain period from among the periods corresponding to a single frame. This is because, if the micro-mirrors in the DMD 430 are turned on, the image sensor 460 cannot detect light. Accordingly, the micro-mirrors in the DMD 430 are turned off.

Subsequently, in operation S340, the image sensor 460 detects the light reflected from the DMD 430. In particular, the image sensor 460 detects light reflected from at least one micro-mirror which is turned off in the DMD 430. Accordingly, the image sensor 460 is disposed on an optical path of light reflected from the micro-mirror that is turned off in the DMD 430.

In operation S350, the control unit 480 determines the area onto which the light source 470 projects the light on the screen 450, using the information detected by the image sensor 460. The information detected by the image sensor 460 may be image information in which only the diffused area is expressed brightly on the entire screen 450. That is, the information detected by the image sensor 460 is image information indicating whether or not light is diffused for the entire screen 450. Since the diffused area on the screen 450 indicates an area onto which the light source 470 projects the light on the screen 450, the control unit 480 can determine the projected area on the screen 450 using the information detected by the image sensor 460.

Following this process, the DLP display apparatus can provide the light source recognition function.

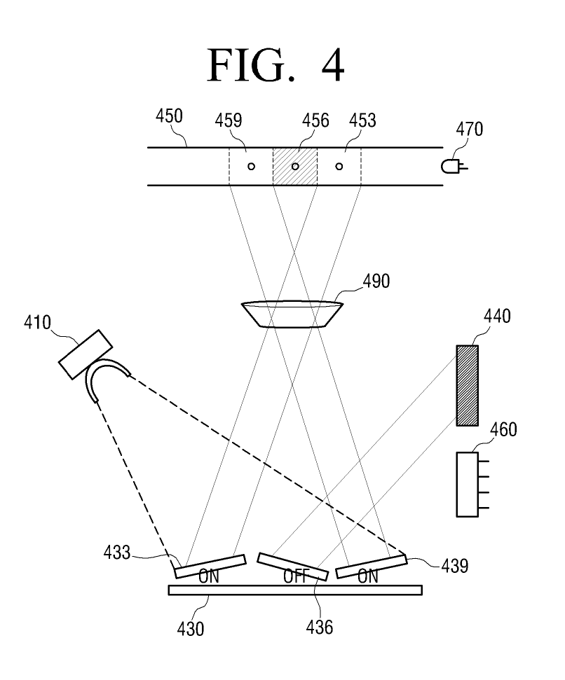

How the touch screen function and the light source recognition function are performed in the DLP display apparatus is described in detail with reference to FIGS. 4 to 8.

FIG. 4 illustrates a process of reflecting light of a display lamp from a DMD to a screen and displaying an image on the screen in a DLP display apparatus according to an exemplary embodiment of the present invention.

As illustrated in FIG. 4, the DMD 430 includes a first mirror 433, a second mirror 436, and a third mirror 439. FIG. 4 shows only a portion of the micro-mirrors in the DMD 430, and it is apparent that the DMD 430 may further include additional mirrors.

The screen 450 includes a first area 453, a second area 456, and a third area 459. The first area 453, the second area 456, and the third area 459, which correspond to the first mirror 433, the second mirror 436, and the third mirror 439, respectively.

The lens 490 focuses light between the screen 450 and the DMD 430.

As illustrated in FIG. 4, the display lamp 410 irradiates a light beam, so that the light beam is filtered by the color wheel 420 (not shown in FIG. 4) and projected to the DMD 430.

Among the mirrors of the DMD 430, light reflected from mirrors which are turned on is projected onto the screen 450. More specifically, since the first mirror 433 is turned on, light reflected from the first mirror 433 is projected onto the first area 453 of the screen 450. Since the second mirror 436 is turned off, light reflected from the second mirror 436 is projected onto the light absorbing unit 440. Since the third mirror 439 is turned on, light reflected from the third mirror 439 is projected onto the third area 459 of the screen 450. Therefore, on the screen 450, only the first area 453 and the third area 459 are expressed brightly, and the second area 456 is expressed darkly.

By following the above principle, the DLP display apparatus can express an image on the screen 450.

FIG. 5 illustrates a user touching the second area 456 on the screen 450 according to an exemplary embodiment of the present invention.

As illustrated in FIG. 5, the light source 470 projects light for total reflection in the screen 450. In this case, the light source 470 uses an infrared ray. If the user touches the second area 456, the total-reflected light is diffused on the second area 456.

The diffused light passes through the lens 490, is reflected by the second mirror 436, and is projected to the image sensor 460. Accordingly, the image sensor 460 detects the touch by the user on the second area 456 of the screen 450.

FIG. 6 illustrates a user touching the first area 453 on the screen 450 according to the exemplary embodiment of the present invention.

As illustrated in FIG. 6, the light source 470 projects light for total reflection in the screen 450. In this case, the light source 470 uses an infrared ray. If the user touches the first area 453, the total-reflected light is diffused on the first area 453.

The diffused light passes through the lens 490, is reflected by the first mirror 433, and is projected to the image sensor 460. Accordingly, the image sensor 460 detects the touch by the user on the first area 453 of the screen 450.

As described above, the touch screen function can be implemented by adding only the image sensor 460 and the light source 470 to the DLP display apparatus.

FIG. 7 illustrates light projected from the light source 470 to the second area 456 on the screen 450 according to another exemplary embodiment of the present invention.

As illustrated in FIG. 7, the light source 470 externally projects light onto the second area 456 of the screen 450. In this case, the light source 470 may be a light source using a visible ray (for example, a laser pointer). As illustrated in FIG. 7, light projected by the light source 470 is diffused on the second area 456.

The diffused light passes through the lens 490, is reflected by the second mirror 436 of the DMD 450, and is projected to the image sensor 460. Accordingly, the image sensor 460 detects the projection of the light source 470 on the second area 456 of the screen 450.

FIG. 8 illustrates light projected from the light source 470 to the first area 453 on the screen 450 according to another exemplary embodiment of the present invention.

As illustrated in FIG. 8, the light source 470 externally projects light onto the first area 453 of the screen 450. In this case, the light source 470 may be a light source using a visible ray (for example, a laser pointer). As illustrated in FIG. 8, light projected by the light source 470 is diffused on the first area 453.

The diffused light passes through the lens 490, is reflected by the first mirror 433 of the DMD 450, and is projected to the image sensor 460. Accordingly, the image sensor 460 detects the projection of the light source 470 on the first area 453 of the screen 450.

As described above, the light source recognition function can be implemented by adding only the image sensor 460 and the light source 470 to the DLP display apparatus.

If the DLP display apparatus has the touch screen function or the light source recognition function as described above, an optic axis of light displayed on the screen is the same as an optic axis of light used to recognize touch or a light source, so calibration or correction is not needed. Therefore, calibration and distortion between coordinates of the image and coordinates of the touch area can be minimized.

In the above exemplary embodiments, the DLP display apparatus may be any kind of display apparatus using the DLP technology, such as a DLP television for example.

As can be appreciated from the above description of the exemplary embodiments of the present invention, a method for providing a user interface, by which a DMD reflects light emitted from a light source to a screen and an image sensor detects the light reflected from the DMD, and a DLP display apparatus using the method are provided, so as to more easily provide a user interface for the DLP display apparatus.

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A Digital Light Processing (DLP) display apparatus, comprising:
a light source which projects light on a screen;
a Digital Micro-mirror Device (DMD) which comprises a plurality of micro-mirrors, and if the light projected from the light source is diffused on the screen, the DMD reflects the diffused light; and
an image sensor which detects the light reflected from the DMD.

2. The DLP display apparatus according to claim 1, wherein the image sensor detects light reflected from at least one micro-mirror which is turned off in the DMD.

3. The DLP display apparatus according to claim 2, wherein the DMD turns off all of the micro-mirrors in the DMD for a certain period among periods corresponding to a single frame.

4. The DLP display apparatus according to claim 1, wherein the light source projects the light for total reflection in the screen, and the total-reflected light is diffused on an area touched by a user on the screen.

5. The DLP display apparatus according to claim 4, further comprising:
a control unit which determines the touched area on the screen using information detected by the image sensor.

6. The DLP display apparatus according to claim 4, wherein the light source uses an infrared ray.

7. The DLP display apparatus according to claim 1, wherein the light source externally projects the light onto a surface of the screen, and the projected light is diffused on the surface of the screen.

8. The DLP display apparatus according to claim 7, further comprising:
a control unit which determines an area onto which the light is projected on the screen using information detected by the image sensor.

9. The DLP display apparatus according to claim 7, wherein the light source uses a visible ray.

10. A method for providing a user interface for a Digital Light Processing (DLP) display apparatus, the method comprising:
projecting light on a screen;
at a Digital Micro-mirror Device (DMD), if the projected light is diffused on the screen, reflecting the diffused light; and
at an image sensor, detecting the light reflected from the DMD.

11. The method according to claim 10, wherein in the detecting operation, light reflected from at least one micro-mirror which is turned off in the DMD is detected.

12. The method according to claim 11, further comprising:
at the DMD, turning off all of the micro-mirrors in the DMD for a certain period among periods corresponding to a single frame.

13. The method according to claim 13, wherein in the projecting operation, the light is projected for total reflection in the screen, and the total-reflected light is diffused on an area touched by a user on the screen.

14. The method according to claim 10, further comprising:
determining the touched area on the screen using information detected by the image sensor.

15. The method according to claim 13, wherein the light projected for total reflection in the screen is an infrared ray.

16. The method according to claim 10, wherein in the projecting operation, the light is externally projected onto a surface of the screen, and the projected light is diffused on the surface of the screen.

17. The method according to claim 16, further comprising:
determining an area onto which the light is projected on the screen using information detected by the image sensor.

18. The method according to claim 16, wherein the externally projected light is a visible ray.
